(19) United States
(12) Patent Application Publication
(10) Pub. No.: US 2004/0145242 A1
(43) Pub. Date: Jul. 29, 2004

(54) Power supply with electrical attributes programmable by manufacturer

(76) Inventors: Edward T. Rodriguez, Winchester, MA (US); Gary R. Fuchs, Princeton, MA (US)

Correspondence Address: CESARI AND MCKENNA, LLP, 88 BLACK FALCON AVENUE, BOSTON, MA, 02210, US

(21) Appl. No.: 10/755,646

(22) Filed: Jan. 12, 2004

Related U.S. Application Data
(63) Continuation-in-part of application No. 10/215,281, filed on Aug. 8, 2002, now abandoned.
(60) Provisional application No. 60/310,994, filed on Aug. 8, 2001.

(51) Int. Cl. H02J 1/00

(52) U.S. Cl. 307/11

(57) ABSTRACT

A high density, multiple output switching power supply having internal mechanical and/or computer generated means for programming multiple operating specifications. The power supply defines a mass-produced base model, fully tested to a relevant safety or operating standard. The base model can be stocked and reprogrammed at the manufacturer or distributor locations into any one of a multitude of substantially different models, each meeting the relevant standards, that is then delivered directly to the end user.

### CROSS-REFERENCE TO RELATED APPLICATIONS

The present application is a continuation-in-part of U.S. application Ser. No. 10/215,281, filed Aug. 8, 2002 entitled “Programmable Power Supply,” by the same inventors and of the same ownership. The present application also claims the benefit of U.S. Provisional Patent Application Serial No. 60/310,994, which was filed on Aug. 8, 2001, entitled “Programmable Power Supply,” by the same inventors and of the same ownership. These two applications are hereby incorporated herein by reference.

### BACKGROUND OF THE INVENTION

1. Field of the Invention

The present invention is related to power supplies, and more particularly to programmable, modular power supplies designed to meet industry standard specifications and approvals, especially industry safety standards.

2. Background Information

For the 35 years that switching power supplies have been generally available, there has been a continuing interest in devising means to more quickly design custom or semi custom configurations. Without such means, custom designs have typically required substantial cost and development time and have furthermore resulted in products that exhibited performance anomalies until production histories were established.

While manufacturers would ideally design and produce standard products and keep them in inventory for prompt delivery, it has become a virtual economic impossibility for firms to inventory the vast number which might be required. As a result there is typically a lead time of 2 to 8 weeks for delivery of catalog items. This is especially true for power supplies rated over 250 watts.

It is well known in the art to use resistor dividers, integrated circuits and discrete components in linear, and switching, and any other type of regulated power supply. Indeed, there are many supplies where the user can adjust an electrical parameter, for example the output voltage. These are often referred to as programmable power supplies. However, there are no manufacturers making a multi-output power supply that has passed a relevant safety or performance standard for a base model where virtually all the parameters in that base model can be simultaneously reconfigured while preserving the relevant safety or performance standards. This reconfiguration changes the entire personality of the power supply and is performed at the manufacturer or at a distributor set up with proper equipment, not by a customer. The reconfiguration is made when a customer requests a particular set of parameters.

The base model is presented to the relevant safety or performance standard testing organization configured at the maximum or other levels for the particular parameters or specifications wherein all modifications are guaranteed to pass the relevant standard.

The situation is quite analogous to the furniture industry. If one seeks to buy a sofa, the process typically involves choosing the design but waiting 6-8 weeks for a sofa with a chosen fabric. It would be economically impossible for the store to inventory the sofa in every possible fabric.

In the early 1980's commercial products were introduced which were based on configurable modules. That is, a series of standard modules were designed with the intent that these standard elements could be quickly put together as building blocks, in accordance with certain guidelines, to create a complete, custom unit. Since that time over a dozen firms have introduced such design and assembly techniques, known as “modular configurables.”

Modular configurable supplies were offered originally by PowerTec, PowerOne and Advanced Power. Later suppliers include Astec's “MVP” (a trademark of Astec) series, Lambda's “Ultraflex” (a trademark of Lambda) series, Magnetek, and Artesyn. Vicor has for some time marketed a family of modular configurables based on assemblages of its pre-manufactured DC converter modules.

Adjustable or programmable power supplies have been available for decades. Bench mounted laboratory supplies are commonly available with potentiometers to adjust voltages and current limits. More recently such supplies have become available with means for digitally programming voltage or current from an external computer. Very recently, certain DC-DC converter modules known as voltage regulator modules (VRM's) and point of load (POL) modules have been introduced. Typically used to power advanced microprocessors, the output voltage of VRM's are programmed by an external means, for example from a microprocessor in order to optimize the microprocessor performance.

In a related area, digital potentiometer chips are now available. Such chips simulate conventional rotary, mechanical potentiometers. However they required an external voltage to function and typically must be reset. Therefore, although they have limitations, they can be used for programming purposes.

A limitation of the known programmable supplies and related electronics is their narrow range of applications. Consequently, they have not found use as the primary power management system in what might be called mainstream power supplies for a broad range of electronic systems. One reason is that these known supplies inherently require a level of technical support sophistication incompatible with simple “point of sale” programmability. Other reasons include cost and packaging limitations. The present invention is directed, among other objectives, toward relieving these limitations.

Another limitation is that seemingly fully adjustable or digitally programmable laboratory power supplies do not incorporate adjustability of all the characteristics necessary in a commercial OEM multi-output power supply. OEM stands for “Original Equipment Manufacturer” which is a term of art given to equipment sold for inclusion into a separate final piece of equipment for the end user.

More recently the industry has been demanding a new class of performance capabilities known as redundancy or “hot swap” in which the unit can be replaced without shutting down power. Modular configurable products do not incorporate this hot-swap capability. Furthermore as more and more firms produce “off shore,” it has become costly to stock the modules necessary to configure the wide variety of power supplies, and therefore off the shelf supplies configured supplies are rare. This is in conflict with the just-in-time delivery pressures of industry. A single reconfigurable base unit addresses this limitation of the prior art.

The broad electronic, computer system applications require a broad range of different power voltages, currents, and power levels. Those applications typically are supplied with a number of prior art modular power supplies each with a different fixed output. There is a variety of modules each with an output voltage and current, and a chassis is provides for mounting a number of these different modules. The user specifies the modules needed and mounts them in the chassis. The different outputs are then fed to the electronic systems involved. No one heretofore has designed a single module with enough outputs at given power levels such that one manufacturer-programmable module provides for the needs of a broad range of electric, computer system.

A result is that available modular configurable power supplies have failed to penetrate the “commodity” use for general electronic systems. There is market need that the present invention addresses for a better alternative to customization without the attendant cost, size and performance limitations. stocking all the variations uneconomical—therefore there is typically a very long waiting period) making it difficult to meet delivery times for any given model. Power supply variations are much more complex than the variations in the sofa analogy making for a lengthy delivery time for a specific supply.

It is an object of the present invention to provide a single manufacturing platform from which a single, pre-produced, pre-tested, inventoried model can be “programmed” by the manufacturer into hundreds of different models by a relatively unskilled person. The approach is for the base model to be stocked by distributors, who then configure the base model to meet the desired needs of the user and deliver that model directly to the user from stock.

Virtually 100% of power supplies sold today in the U.S. also must be tested and approved by Underwriters Labs or similar safety agencies. It is an object of the present invention to provide a platform where the programming methodology does not affect the approval rating. That is, once the standard model is approved, all variations are correspondingly approved. This obviates the expense of individual supply configuration approvals. Testing to other performance or safety standards, like TUV, DIN, etc., are accommodated by the present invention.

Another objective of the present invention is to identify the most popular base model and the multitude of popular different models and how they would vary from the base model. This versatility requires that the base model be “over-designed with wide operating and safety margins,” and this over-design is an objective of the present invention.

More specifically a prior art practice in power supply design is to optimize the design of transformers, outputs rectifiers, output chokes, and output filter capacitors in accordance with whether such outputs are specified, for example, at 5v, 3.3V, 2.2V etc. or for current ratings 70 amps, 50 amps, 30 amps etc. It is an objective of the proposed invention to achieve those ends without this narrow optimization. That is, the present invention

It is normal industry practice to have separate, but perhaps similar, designs, to accommodate all the possible combinations of characteristics as just outlined. With receipt of a purchase order, a firm might then modify a unit with the appropriate changes required. In practice, the achievement of this goal on a timely basis is very difficult even though it is seemingly straightforward. Furthermore, it is known in the industry that each time a change, however small, is introduced into a production line, the possibility of error increases.

There are numerous patents in the general field of “programmable power supplies.” But, this term is used to describe power supplies where the customer may make changes. One such patent, U.S. Pat. No. 4,569,009 to Genuit, describes basic techniques for programming voltage levels, and points out the need to concurrently program other parameters, e.g. over-voltage protection and “good” DC thresholds. U.S. Pat. No. 5,103,110 to Houseworth et al. describes techniques for selecting output voltage or current characteristics. U.S. Pat. No. 5,917,311 to Brokaw describes methods —of employing arrays of resistors in divider networks to select discrete voltage outputs. U.S. Pat. No. 4,193,104 to Nercessian describes selectable voltage dividers circuits to select over-voltage circuit protection as noted in U.S. Pat. No. 4,569,009, above. None of these patents describe the manufacturer's ability to reconfigure a multi-output power supply as described in the present invention.

One major growth market for configurable, programmable power is for networking and communications equipment. Two sets of power supply performance specifications have been developed for these applications.

One set addresses signals and diagnostics. That is a power supply is expected to provide certain signals indicating its operating status and incorporate protection against certain fault conditions.

The second set addresses voltage and current ratings. These ratings have many variations (a sofa analogy where the type of sofa and all the variations in fabric make provides a baseline design, capable of the highest voltages, power ratings, and the highest currents specified. This embodiment is defined as “overdesigned” for its intended configurations. All subsequent programming changes are implemented to only provide equal or lower voltages power, or current ratings from that baseline unit. In this manner all the various configurations will meet the applicable safety and other standards.

Furthermore, it has long been an issue for power supply manufacturers that, after modifying a design, they usually go through the cost and time delay of submitting a sample, or technical data to Underwriters Laboratories (UL) or a similar safety-certification agency to validate certain of the ratings. The approval protocols of UL and other safety and standards groups are such that an approved unit can be manufactured and modified into any number of versions and sold as a listed or accepted unit item as long as a baseline unit has been approved and the modifications fall within specifically documented lower voltage and/or current ratings.

The proposed invention provides an “overdesigned” base unit meeting the UL or other protocols. The hundreds of possible reprogrammed modifications are all documented to be of a lower voltage and/or current rating so all the programmed versions are automatically approved.

In other words it is an object of the present invention that programmability maintains UL approval wherein supplies made in accordance with the present invention are essentially invisible to the end customer as if the supplies were design-optimized and manufactured expressly for that user.

### SUMMARY OF THE INVENTION

In view of the foregoing background discussion, the present invention recognizes and provides a multi-output. preferably a five output, hot swappable, single assembly power supply that is reconfigurable by the manufacturer that will satisfy a large portion of the general computer, networking electronics system needs. Moreover, a single assembly will allow cost to be driven down by volume production of a single base unit, reliability improved by testing and employing wide design margins, and availability improved as distributors need only stock and handle one base unit module. The base unit can be submitted to UL or other such safety or performance testing group and approved in all the various possible configurations.

In one preferred embodiment, programming of all virtual modules by the manufacturer or distributor is accomplished by using subminiature, surface mounted digi-switches, accessible from outside the unit. Repositioning of the switches requires a miniature tool, thereby eliminating the possibility of inadvertent manual change. A base model may be mass produced and inventoried with all switches in a particular position, constituting the most popular model. The base model is stocked at distributors who then program the base model to the specifications of the user and deliver that unit to the user substantially directly from stock.

While the subminiature switches are accessible for purpose of programmability, they become inaccessible once the power supply module is installed in a system enclosure, thereby meeting an objective of non-adjustability by an end user during system operation.

An order for any one of the many combinations is produced by changing switch positions. The result is virtual instant delivery of any one of a large number of models while still exhibiting instant safety approval, the predictability of a mass produced item and the features of a highly customized unit.

In one preferred embodiment the power supply is design to exhibit what is viewed as the most modular configuration incorporating all of the size and performance benefit deemed most desirable.

In another preferred embodiment, the switches may be solid state devices that may be remotely programmed via local or internet connected computers.

It will be appreciated by those skilled in the art that although the following detailed description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is block diagram of a single manufacturer programmable power supply;

FIG. 2 is an isometric drawing of a power supply assembly showing access to the programming switches;

FIG. 3 is a functional schematic drawing of a multi-output switching power supply made in accordance with the present invention;

FIG. 4 is a functional schematic of a settable current limit circuit used in FIG. 3;

FIG. 5 is a functional schematic of a settable current sharing circuit used in FIG. 3;

FIG. 6 is a functional schematic of a settable DC voltage setting circuit used in FIG. 3;

FIG. 7 is a functional schematic of a settable DC GOOD circuit used in FIG. 3;

FIG. 8 is a functional schematic of a settable over voltage sensing circuit used in FIG. 3;

FIG. 9 is a functional schematic of the opto-isolator circuits used in FIG. 3

### DETAILED DESCRIPTION OF ILLUSTRATIVE EMBODIMENTS

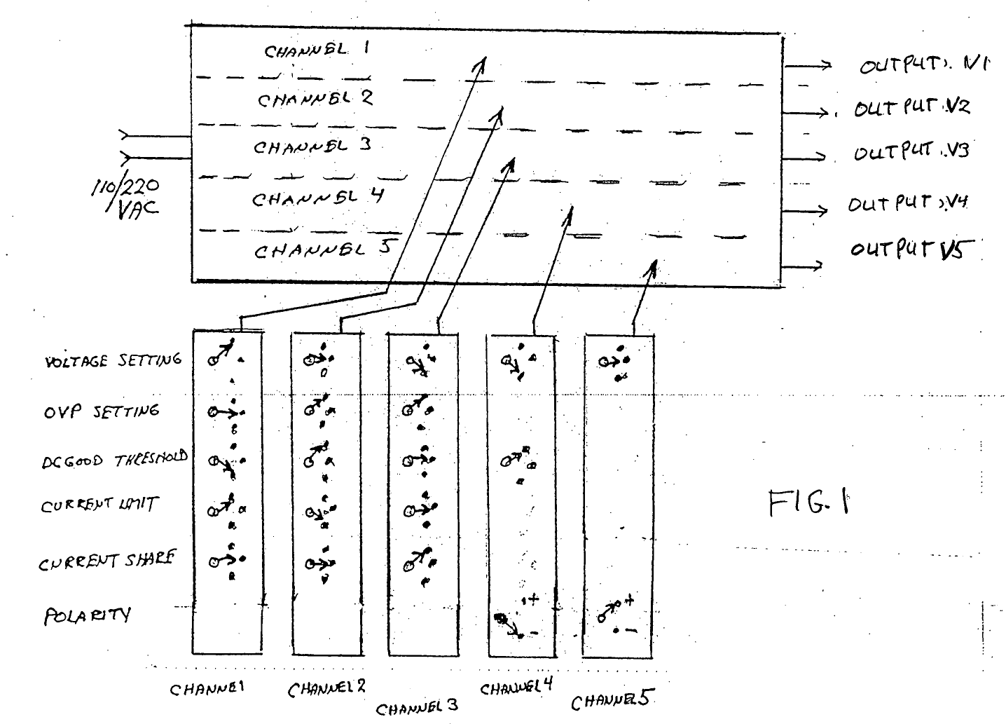

FIG. 1 shows a simplified block diagram of a power supply of five channels or output voltages with symbolic representation of switches for changing parameter set points. As shown, outputs V1, V2, and V3 are fully reconfigurable with respect to output voltage setting, over voltage setting, DC GOOD setting, current limit setting and current sharing setting. V4 has a voltage, DC GOOD and polarity setting, while V5 has only voltage and polarity settings. Here “setting” refers to switch selection positions.

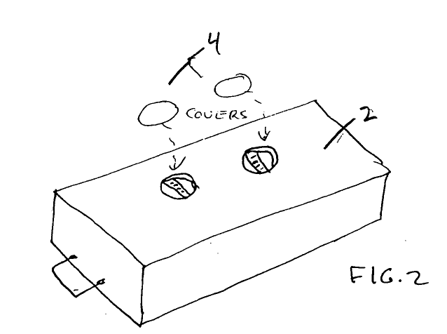

FIG. 2 shows a representative of the switches of FIG. 1 as accessible through the housing 2 of a power supply with covers 4 that will prevent later changes by users. Those skilled in the art would know that different packaging configurations might require the PC board to be a single board or two or more small boards. Those skilled in the art may also recognize that various combinations of switches and the resistors those switches select can in certain circumstances be replaced by integrated circuits such as the DS 1809 non volatile digital potentiometer, made by Dallas Semiconductor.

A preferred embodiment of the present invention provides a five output programmable module including two high current outputs, an additional output with a reduced current rating and two additional, lower current auxiliary outputs. The following parameter specifications and definitions apply:

1. Voltage setting The highest current voltage outputs are programmable to power logic circuits. Voltage levels typically are 5V, 3.3V, 2.5V, 1.8 V, or even below 1V. But emitter coupled logic levels of 0.8V to 1.6V may be programmed.

2. Overvoltage Protection setting The programmable OVP circuit guarantees power supply shutdown if a fault condition results in higher than acceptable output voltage occurs. The setting is slightly above the output voltage. If the output voltage setting is changed, the OVP setting must be changed accordingly.

3. DC Good setting An output signal indicating, after power supply turn-on, that all outputs have reached their desired level within specifications. The power supply contains programmable circuits which monitor each output. These monitor circuits combine for a single “DC Good signal. The single signal may be used by control circuity within the power supply or by a remote computer controller. Remote meaning external to the multi-output power supply in question. If a voltage setting is changed, the monitor circuit threshold for that output has to be adjusted accordingly.

4. Current Limit setting Typically an output incorporates monitor circuits such that if the output current exceeds the rating by a predetermined amount, the output, for protective reasons, is either shutdown, or limited. For example, an output rated for 70 amps might be set so that an attempt to load it to 80 amps would result in a limiting action at 75 amps. It is important to incorporate such current limiting so that the power supply is not inadvertently destroyed by load demands that are not a short circuit but simply moderately excessive. Power supplies virtually always have short circuit protection as a separate standard characteristic. If the power supply has a virtual module intended for programmability to different voltage and power levels, it is very important to be able to change the current limit set point to guarantee performance expectations.

5. Current Share setting When voltage and current levels are changed, the ability of two identical modules to share current, when appropriately interconnected (paralleled) depends on certain analog signals exchanged between the two units. Each unit has an internal circuit that monitors output current and relates it to the specific voltage output. That circuit generates an analog signal that is compared to a similar circuit in a second unit. Each unit compares the signal from the other unit and adjusts internal operation so that the output voltages of both units are close enough to guarantee that the output currents are approximately the same. When various characteristics of a power supply are changed, the internal current share circuits must be adjusted accordingly.

6. Polarity setting It is quite common, especially for auxiliary outputs, to require negative as well as positive voltages. Such negative voltages are typically for bias voltages. Therefore it is desirable for a standard, virtual module to have provision to change output polarity.

Thus it can be seen that a single module outputting five programmable voltage outputs can be tailored to any one of thousands of combinations.

Channel 1 will constitute about 40% of overall power and will be set for a voltage of 1.8V, 2.5V, 3.3V or 5V. Channel 2 will constitute 30% of the power and have the same voltage options. Channel 3 will constitute 20% of the total power but have provisions for 12V, 5V or 3.3V. Channels 4 and 5 will constitute 5% of the power and have provisions for 15V down to 2.5V and polarity reversal as well.

In this preferred embodiment, channels 1, 2 and 3 are programmable using surface mounted, ultra-miniature switches on a PC board. Channels 4 and 5 polarity is programmable using subminiature switches on a PC board. Channels 4 and 5 voltages are programmable using of precision, multi turn, sealed potentiometers on a PC board. Channels 4 and 5 could incorporate switches but these auxiliary voltages are more likely to have need not only for standard voltages but also for nonstandard voltages such as 7.5V, or 9V, etc. The option to use potentiometers in those channels provides an infinite adjustment capability.

While the exemplified embodiment use a certain combination of switches and pots, it would be clear to those skilled in the art that pots or switches could be interchanged in necessary for particular functions. While the exemplified embodiment use a plurality of PC boards to carry the various switches and pots, those skilled in the art could put all on a single PC board if that were compatible with the manufacturing and overall packaging scheme desired. Moreover, it is to those skilled in the art that the programmable resistor chips could be used and programmed by microprocessor or other such computer outputs, even over the Internet or other communications networks, so that the programmability of all the parameters discussed herein can be accomplished using computers.

In a preferred embodiment all of the aforementioned switches and potentiometers accessible through holes in the metallic power supply enclosure. In this manner, it is possible to take a stocked standard model, change switch or potentiometer settings in minutes with a miniature screwdriver or tool and have the new model immediately available for shipping. That is to say, an enormous number of models could be made almost instantly available from a single pre-tested, stocked model.

The result of this approach is that the manufacturing line need only produces a single product and the distributor needs to only stock one model. The customer, on the other hand, gets of the shelf delivery of a large variety of models. The knowledgeable customer even has the option of reprogramming the unit to different characteristics.

In practice, every possible model has associated with it a very simple set of steps as to the setting of the potentiometer or the position of the switch.

The present invention provides characteristics superior to configurable modules due to being a single “over-designed” design, e.g., lower cost, better reliability and easier programming, speed of delivery, and quicker, better and faster repair. The design, reliability, cost, performance, can be optimized with a single design with fewer components as compared to the many different designs found in prior art modules.

Some preferred embodiments of the present invention are as follows, but the invention is not limited to these forms.

A switching power supply having multiple outputs and a number of internal, but externally accessible, subminiature switches or similar mechanical programming means whereby the operation of such means alters the key operating characteristics of each of the outputs after manufacture and test of the original unit, so that the resultant configuration manifests itself as a different model with defined electrical specifications.

A switching power supply in accordance with the above in which the internal mechanical programming means allows the conversion of one model into another by changing, from one level to another in accordance with predetermined set points, output voltage, maximum current limit, over voltage protection threshold, DC Good threshold, output voltage polarity and inter-unit current sharing proportionality scaling factor.

A switching power supply in accordance with the above in which a unit, subject to subsequent change, is always produced and tested in one configuration with mechanical programming means set in a specific position with subsequent re-programmability possible without requiring any subsequent complete or partial disassembly of the unit.

A switching power supply in accordance the above in which the external accessibility to the mechanical programming means is only with an uninstalled power supply module, with such accessibility no longer being readily available once the power supply module installed within a final enclosure.

A switching power supply in accordance with the above through 4 in switch one or more of the switches and associated programmability resistors are replaced by non volatile digital potentiometers which, like a stepping switch, can be set to predetermined resistance settings.

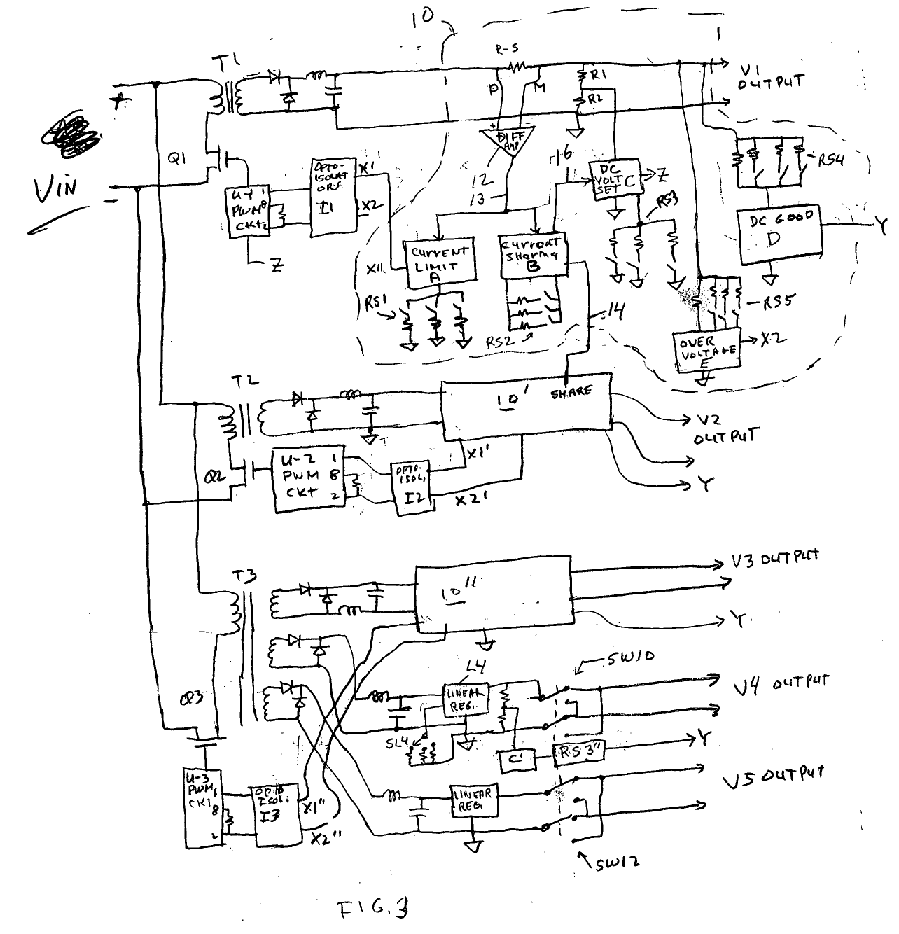

One preferred embodiment of the present invention is shown in FIG. 3, a five voltage output switching power supply. A module with five voltage outputs has been found to satisfy 75% or more of the market requirements. Each of the five outputs is discussed below as a virtual module or “channel.” FIG. 3 shows the five outputs as V1, V2, V3, V4, and V5. Each output is reconfigurable. A DC input signal connects to the primaries of transformers, T1, T2, and T3. There is an earlier AC signal that is rectified (not shown) to provide the DC input signal. Each primary has a series MOSFET, Q1, Q2, and Q3, each driven from a UC 3845 circuit—a power width modulator (PWM) circuit made by Unitrode designated as U-1, U-2, and U-3. Each UC 3845 circuit is driven from an assembly of opto-isolators, I1, I2, and I3. Each secondary, there are five, has a diode rectifier and low pass filter as shown. The entire arrangement of the circuitry just described is well known in the art, and will not be further discussed. However, further information and details may be found in the Unitrode Application Handbook of 1997. This handbook is hereby incorporated herein by reference.

The remaining circuit connections 10 of FIG. 3 are now described, with following descriptions of the circuit blocks of FIG. 3.

Still referring to FIG. 3, voltage output V1 has five selectable parameters, each of which is controlled by a circuit primarily consisting of a comparator or op-amp, reference IC's and a selector switch. Block A, B, C, D, and E, respectively, monitor and control a current limit (i.e., maximum power), current share, voltage settings, DC Good, and Over Voltage Protection circuitry. (OVP). These circuit blocks are discussed in order.

A. Current Limit Block A (FIG. 3):

A voltage is developed across resistor R-S that is a measure of the current output from V1. This voltage is measured by a differential amplifier 12 that outputs a current sense signal 13 to the current limit circuit A and the current sharing circuit B, discussed below. The current limit drives an opto-isolator circuit within I!, that in turns drive the PWM circuit U-1. The current limit setting is determined by the resistor/switch assembly RS1. When triggered by an over current condition the PWM shuts down.

B. Current Share Block B (FIG. 3):

The current sense signal 13 is also connected to the current share circuit B, that in turn connects 16 to the DC voltage setting circuit C that controls the V1 output voltage. Circuit B also connects 14 to a similar current sharing circuit connection in another power supply module outputting V2. In such an instance V1 and V2 would be tied together to share the load. The sharing circuits in each module operate to ensure that V1 and V2 each provide their share of the load current. The current share circuit B is set by the resistor/switch assembly RS2.

C. The DC Output Voltage Block C (FIG. 3):

The DC voltage setting circuit C reads the output voltage via the resistor divider R1 and R2 and provides a feedback connection Z to control the pulse width generated by the PWM circuit that in turn controls the V1 output voltage level. The setting of the DC voltage via block C is accomplished by the resistor/switch assembly RS3, as is well known in the art.

D. DC GOOD block D (FIG. 3):

A DC GOOD circuit is connected to the V1 output voltage via the resistor/switch assembly RS4. When the value of V1 is proper as determined by the RS3 settings, the DC GOOD circuit outputs a signal Y so indicating. The DC GOOD circuit out put Y is available as a status or control signal to an external computer or controller. The Y signals from all the modules are tied together in an “or” arrangement where any one may drive the Y signal to indicate that one or more DC output voltage are in an error condition

E. Over Voltage block E (FIG. 3):

Circuit E monitors the output voltage via resistor/switch assembly RS5, and, based on the RS5 setting. Block E sends a signal X2 to the opto-isolator I1 which disables U-1 if the output voltage exceeds the proper level by the set margin. If the output voltage is changed, this circuit generally must be changed accordingly.

Circuit details as discussed above and below are well known in the art, and many other alternative circuits and techniques for each individual operation are known that will provide similar actions. However, the entire manufacturer programmability of a entire set of output voltage modules is not found in the prior art, and the benefits of such an arrangement have not been recognized.

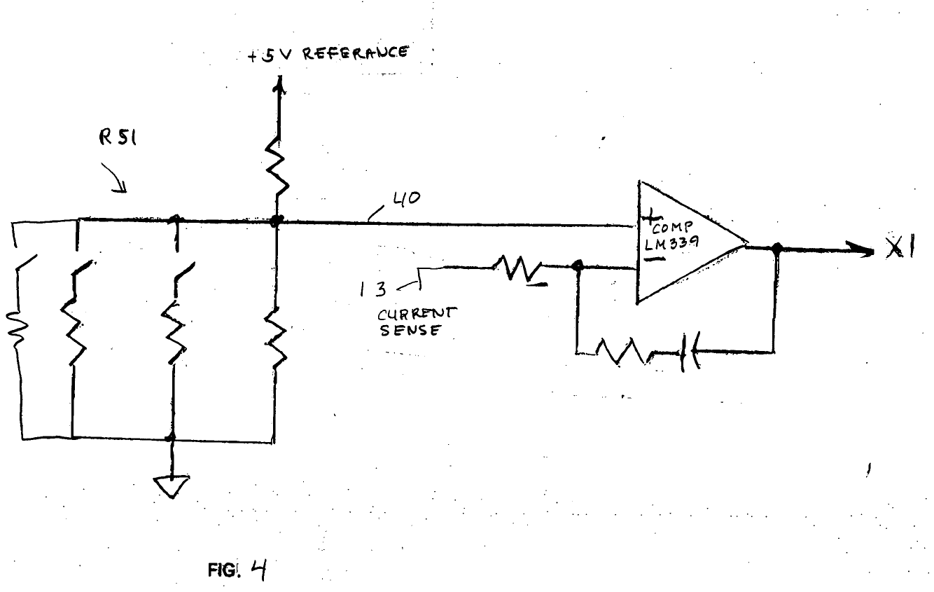

FIG. 4 shows in more detail the current limit block A (FIG. 3). In this case a comparator inputs the current sense signal 13 and compares that level with a level 40 generated by the setting of the resistor/switch assembly RS1 and a +5V reference voltage. The +5V reference (not shown) can be of many different values and generating such a reference voltage is well known in the art. The comparator output X1 drives the opto-isolator I1 which shuts down the PWM U-1 as discussed below.

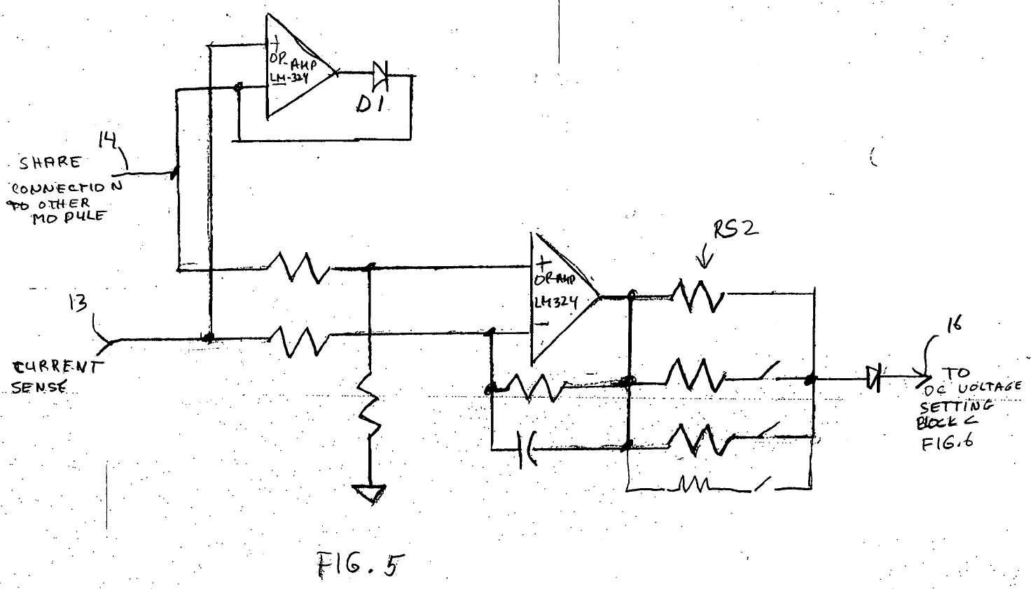

FIG. 5 shows the current share block B (FIG. 3). One input connection comes from the current sense signal 13 and a second from a SHARE 14 connection from another output voltage driving or sharing the load with the V1 output of module 10. In the instance of FIG. 3, module 10′ and module 10 show this connection 14 being made wherein V1 and V2 drive the same load and will share the load current as determined by the setting of the resistor switch assemblies RS2 and the corresponding RS2′ in module 10.′ The out put 16 drives the DC voltage block C to adjust the output voltage to balance the shared load currents as desired.

In a typical embodiment of the product, an output of one power supply can be connected in parallel with a comparable output of a second, similar power supply so as to a) double the total power more b) provide redundancy. For example an output capable of delivering 5V at 50 amps may be connected in parallel with a like output such that the two can deliver 5V at 100 amps. In such an arrangement it is desirable to have the two outputs each deliver current to within a few amps of one another.

That is, it is often deemed unsatisfactory to have one delivering 90% of the power and the other only 10%. during less-than-full-load conditions. This is especially so in redundant operation where such a sharing disparity could result in the lesser burdened supply, in the event of failure of the “burdened” supply, taking too long to come to the full current demanded by the load.

While there have been various techniques used in the power supply industry to guarantee equal load current sharing, a more recent preference has been to employ a technique called “single wire” current share. In such a configuration, the two power supplies to be paralleled have a single wire 14 connected between them. That wire acts as a shared single line, representative of the output voltage. Those skilled in the art are familiar with such techniques and a substantial body of technical literature exists on the details of implementation. Consequently, for the sake of simplicity, only general details will not be included here.

When two power supplies of apparently similar outputs are connected in parallel, they act just as would two batteries with their outputs connected in parallel. It is known to those skilled in the art that two such batteries will share the load current in a manner related to a) how close the respective voltages are to one another and b) the amount of the series resistance between each battery and the point where they are interconnected. If the two voltages are too far apart, one battery will deliver virtually all the current. The same principal applies to power supplies.

Therefore it is necessary to automatically adjust each of the two output voltages so that they are nearly identical. The degree of sharing accuracy is related to the voltage difference and the series impedance. In the preferred embodiment, each power supply has circuits that enable that supply to sense an intelligence bearing voltage on the shared line. That voltage is indicative of the current being delivered by the supply with the highest volt age. The one which is low and not delivering an adequate percentage of current will have its output automatically adjusted upward to be almost identical to that of the other supply. Consequently, the current sharing circuitry is primarily a mechanism to adjust voltage of paralleled supplies so that they are nearly equal. 5V supplies need to be adjusted to 5 volts plus or minus a few hundredths of a percent. If it is a 3.3 volt supply then of course the adjustment is to 3.3V plus or minus that percentage.

In the preferred embodiment, the appropriate circuit, as shown in FIG. 3 and FIG. 5 there is a need to compare a) the current sense signal 16 to determine whether the current of that supply in question is too high or too low for proper sharing, and b) the corresponding current sense signal of the local supply with the highest voltage. If the “other” supply has higher voltage, the circuit will adjust the local voltage higher so that the local supply will provide more current to the shared load. If the local voltage is already the highest, nothing will be done and the adjustment takes place in the other supply.

In order for supplies to adjust respective voltages to the proper level, they necessarily must know what the intended voltage is. Referring to FIG. 5, RS2 is a resistive voltage divider with other circuitry which controls, via the DC voltage setting block C, the PWM of the supply in question and therefore its output voltage level. The resistive values for RS2 are set to ensure that the current share adjustment mechanism is attempting to adjust the voltage only up to the desired amount. This means that programming a supply from having a 5 volt output to one with a 3.3 volt output necessitates changing the divider so that the current share voltage algorithms get recalibrated

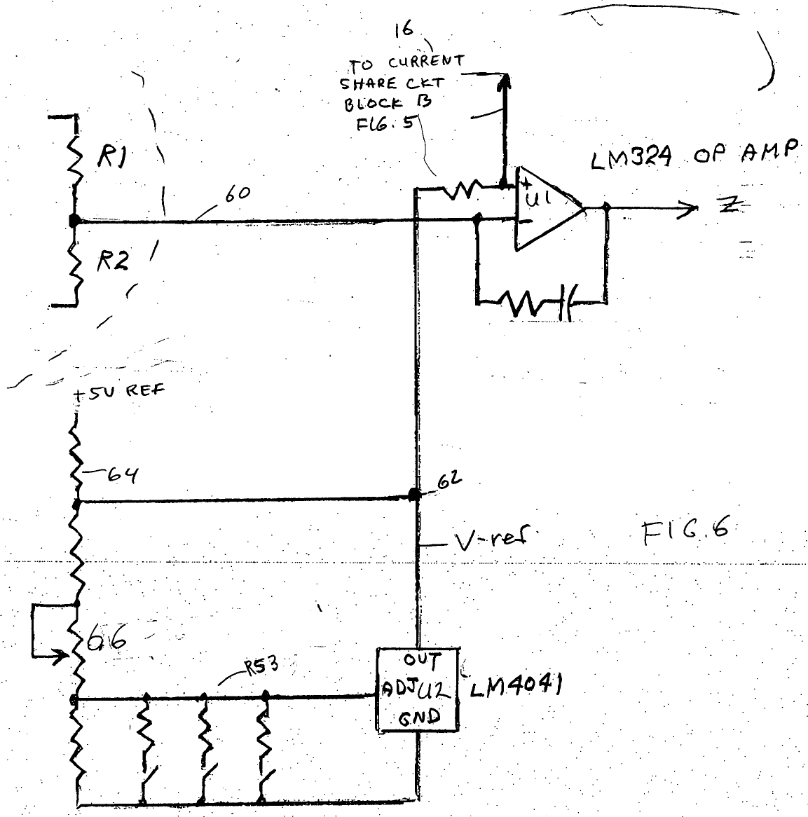

FIG. 6 details one embodiment of a DC voltage setting module C (FIG. 3).

Module C monitors the voltage across the output circuit voltage divider network, R1, R2. It is well known that, although R1 and R2 are shown within item 10 (FIG. 1), they may be placed remotely at the load to thereby regulate the voltage level at the load. The output Z of U1, preferably an LM324 op-amp (LM designations are virtually generic), drives (Z) the PWM circuit to establish the desired V1 DC output voltage setting. In this case, a voltage, representative of the output voltage at the point of load, is sensed at terminal 60 and sent to the operational amplifier U1. Within U1, the voltage 60 is compared with a reference voltage from 62 that causes an appropriate voltage Z to be sent from U1 to the pulse width modulator (PWM) circuit which controls the duty cycle of the main power switching circuit, thereby increasing or decreasing the V1 output voltage. Those skilled in the art are familiar with the basics of such PWM control of power circuits as a means to control output voltage.

In this case the reference voltage of point 62 is derived from a circuit which uses an adjustable voltage reference integrated circuit, U2, typically an LM4041, and a number of selectable resistors RS3. The selection of different resistors via RS3, as shown, together with the potentiometer POT results in a number of very precise voltage reference signals being set and maintained at point 62. A +5V reference (generated by well known circuits) supplies the RS3 assembly through a resistor 64 and the potentiometer 66. The signals 60 and 62 combine to provide an number of output voltages at Z, that in turn cause the switching circuit PWM U-1 to drive the output voltage to different levels in accordance with the state of RS3.

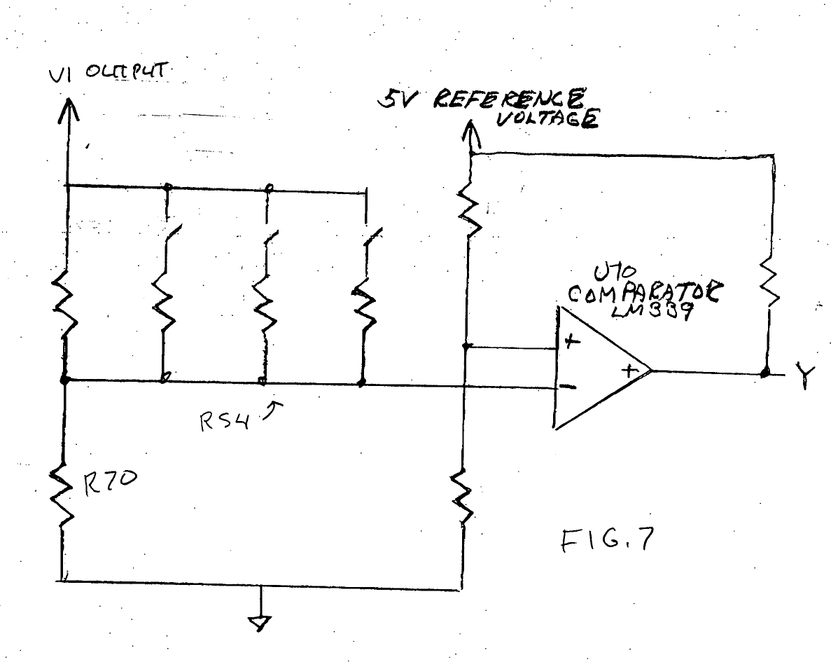

FIG. 7 shows an illustrative circuit for the DC GOOD block D (FIG. 3): U70 is typically a LM339 type integrated circuit with an open collector or drain allowing an “or” connection with other similar outputs. One input to the comparator U70 comes from a resistive voltage divider formed by RS4 assembly and R70. The other input is formed from a voltage divider of +5V references source. When a comparison is made at U70 between the reference voltage and the voltage input from the divider, the output Y signal is made available to an appropriate circuits in the power supply or to an external controller indicating that the voltage across the sense terminals is within a desired range and therefore “good.” As was noted earlier, the V1 voltage sensed, in a preferred embodiment, may be reflective of the power supply output voltage at the point of load.

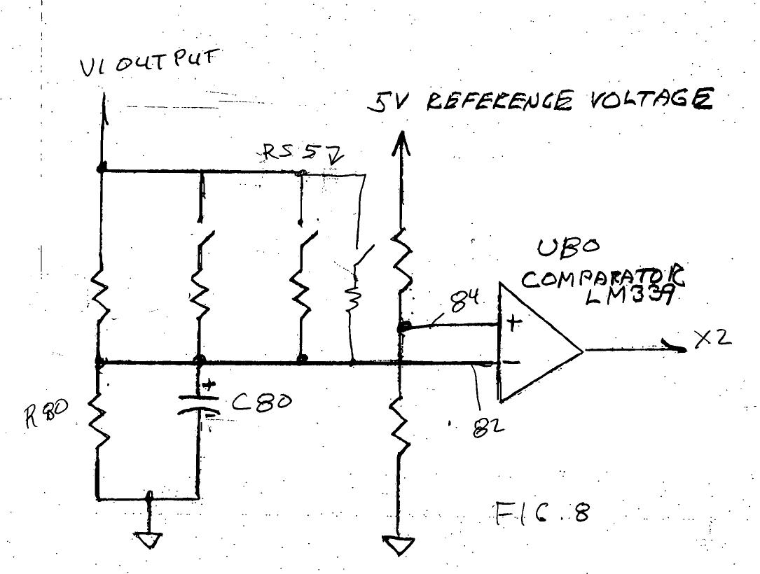

FIG. 8 shows one embodiment of an over voltage protection circuit of block E (FIG. 3). There are a number of traditional ways to achieve protection in the event the output voltage rises to levels that might damage load circuits. Those skilled in the art are familiar with the use of a simple Zener diode across the output. However this is useful only for extremely short duration voltage excursions, since the Zener diode typically has negligible long duration power dissipation capability

Another approach is to use a SCR as what is called a “crowbar switch” to short circuit the output, causing short circuit protection mechanisms to turn the supply off or to blow fuses. Consequently the crowbar approach does not typically offer auto recovery after fault removal. In either the clamping method or the crowbar method, there is typically permanent failure of some power supply component, intended or not, as a means to protect output circuits should a fault be likely to occur for more than a second or two.

FIG. 8 shows a circuit that can be employed in an automatic recovery mode or in a shutdown-and-restart mode. In either event, there is no possibility of damage to any component. One input to the comparator U80 comes from a selectable voltage divider formed from the resistor/switch assembly SW5 and R80. A 5V voltage reference is onnected to the other input to U80. When the voltage at 82 exceeds that at 84 a signal X2 is sent to the PWM U-1 via an opto-isolator that shuts the PWM down. Such shutdown circuits can be made latching or non latching in accordance with standard techniques familiar to those skilled in the art.

It can be seen that RS5 can select resistors to modify the voltage divider and thereby determine the over voltage level. A capacitor C80 is employed to interject a small delay so that circuit noise or random, very short duration output voltage transients do not inadvertently cause shutdown.

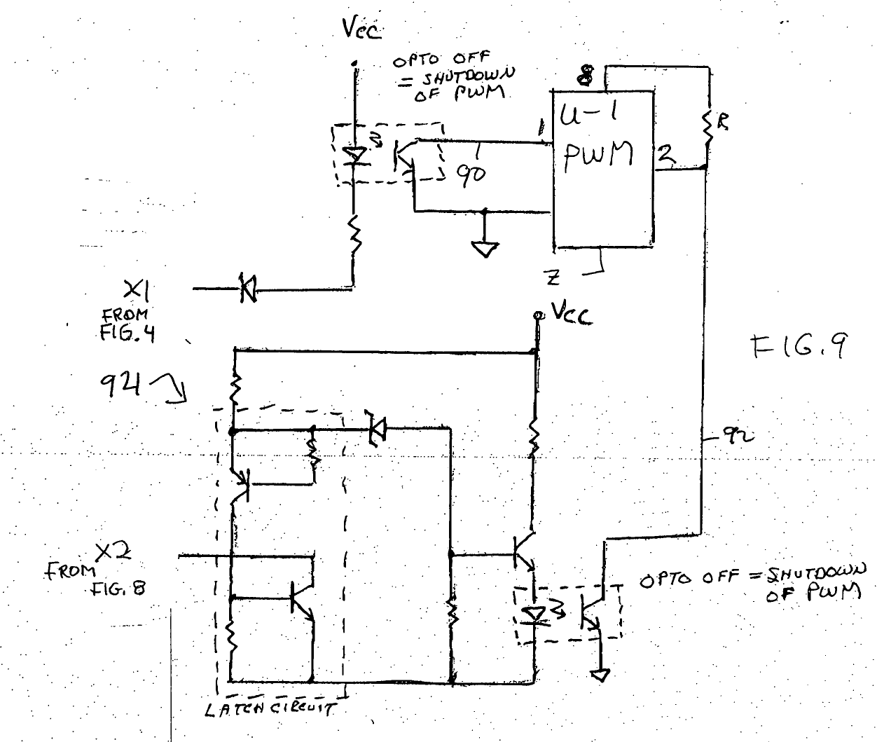

FIG. 9 shows more details from the shut down opto-isolator circuits described above. X1 comes from FIG. 4 current limit circuit and X2 from the over voltage protection circuit of FIG. 8. The arrangement with U-1 a Unitrode UC 3845 circuit is arranged so that both opto-isolators are “on”—that is the output transistors are on and points 90 and 92 are both low when the power supply is operating normally with no over voltage sensed or current limit exceeded. Circuit detail 94 indicates a latching operation that can be replaced with the simpler circuit from X1, or could alternatively be used in the X1 circuit. Vcc can be the +5V reference circuit mentioned above.

Referring back to FIG. 3, circuit module 10 is used for outputs 2 and 3, as 10′ and 10,″ respectively. Typically the specific settings of outputs 2 or 3 may be different.

Output Voltage V4 is an auxiliary output derived from output No. 3. It incorporated a circuit C′ and resistor/switch assembly RS3″ function similar to block C, but not A, B, D, or E. In this section L4 is an adjustable-type linear regulator and those skilled in the art know that such regulators commonly have their output voltage set by an external resistor. Switch SL4 and the related three resistors perform that function. In this case the voltage selectability is performed differently from that of circuit C for outputs 1, 2, and 3 but the result is similar.

Output 5 is virtually identical to output 4 except that the voltage output is not shown as being monitored and sent to the DC GOOD summing circuit. Such inclusion or exclusion is a function of the specific design objectives for a particular power supply.

Outputs 4 and 5 also include switches, SW10, SW12, that, acting in a double pole/single throw manner, can reverse the polarity of either output. Double pole/double throw switches are shown here but individual single pole/single throw or double throw switches can be connected to perform the same function on any output.

Even though the above circuit description describe switches, solid state FET's, or the like, can be used to perform the same functions. As such the FET's may be controlled, as known in the art, by externally generated logic signals. Moreover, these logic signals can emanate from an external source and even by remotely set. As such, the programmability by setting the switches of the present invention can be accomplished with one of more computer systems that may be remote from the power supplies. In one approach, the programmability might employ a linear resistor that is selected remotely. The output of the linear resistor will replace the switched RS's in the above circuits as may be accomplished by those skilled in the art. The remote programmability may accomplished via the Internet or another communications network. The linear resistor that is partitioned into sixty four different positions each of which is connected to an output. UP and Down inputs are provide that increment the wiper 66 location in the direction indicated. These inputs are compatible with typical digital logic signals that can be supplied by virtually any logic or computer system.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A multiple voltage output, switching power supply operating at a given frequency, accepting an AC power input, and wherein the switching power supply meets a set of safety and operating requirement, the power supply comprising for each of a number of multiple outputs at least one of:
a rectifier and filter that converts AC to DC,
a control circuit for controlling the duty cycle of the given frequency,
a DC output level controlling circuit for monitoring and controlling a DC output level via the control circuit,
a current limit circuit for monitoring the current supplied by a DC output, wherein if the current limit is exceeded the corresponding control circuit is shut down,
a over voltage threshold circuit, wherein if the over voltage limit is exceeded the corresponding control circuit is shut down
a DC good circuit connected to a DC output voltage and providing a signal indicating the acceptable or unacceptable status of the DC output voltage level,
a first load current sharing circuit defining an output to the corresponding circuit for monitoring and controlling a first DC output level, and defining a connection to a second load sharing circuit that defines an output to the corresponding circuit for monitoring and controlling a second DC output level, wherein the first and the second DC outputs share a load current, wherein the first and the second load current sharing circuits balance the currents between the two DC outputs, and further comprising:
means for programming the DC output levels,
means for programming the current limit circuit,
means for programming the over voltage limit circuit,
means for programming the DC good circuit,
means for programming the first and the second current sharing circuits, and
switching means for polarity reversal on at least one of the multiple outputs, wherein operating the above programming means provides a different personality of the switching power supply.

2. The switching power supply of claim 1 wherein each of the means for programming comprises and resistor and switch assembly.

3. The switching power supply of claim 1 wherein one configuration of each of the means of programming is selected to define a base model, wherein if the base model meets an applicable safety standard all the other programmable configurations automatically meet the standard.

4. The switching power supply of claim 1 further comprising: a housing encompassing the switching power supply with an opening allowing access to the means for programming, and a cover over the means for programming secured to the housing such that a user will be prevented from altering the programmed settings.

5. A method insuring that a multiple output, programmable switching power supply meets a set of safety specifications over the range of the programmability, the method comprising the steps of:
selecting a configuration of programmable settings that define a base model, wherein if the base model meets an applicable safety standard all the other programmable configurations automatically meet the standard.
